(19) United States
(12) Patent Application Publication
(10) Pub. No.: US 2016/0148310 A1
(43) Pub. Date: May 26, 2016

(54) COMPUTER-BASED DATA COLLECTION USING A PREDICTION MARKET WITH A LIQUIDITY REDUCING COST FUNCTION

(71) Applicant: Microsoft Technology Licensing, LLC, Redmond, WA (US)

(72) Inventors: Miroslav Dudik, Brooklyn, NY (US); Rafael Frongillo, New York, NY (US); Jennifer Wortman Vaughan, New York, NY (US)

(21) Appl. No.: 14/548,531

(22) Filed: Nov. 20, 2014

(51) Int. Cl. G06Q 40/04

(52) U.S. Cl. CPC G06Q 40/04

(57) ABSTRACT

A computer system implements an automated multi-user, multi-event real-time online prediction market, thus providing a more efficient and accurate mechanism to collect opinion information in digital form. The amount of liquidity in the market can be changed as a function of time to reflect how valuable information is at any given time. A computer that implements a prediction market, which offers securities for a plurality of events, is programmed to allocate a data structure for storing a transaction history, access current time information and define a cost function for the market. In one implementation, the cost function switches from a first function to a second function at a point in time prior to occurrence of an event. In another implementation, the cost function can be time dependent so as to gradually change over time.

### BACKGROUND

There are a number of ways to gather opinion data from the general public, such as polling and surveys. More recently, prediction markets also have been increasingly used. A prediction market is a centralized market in which users purchase contingent securities. A contingent security has a value that is dependent upon a currently unknown outcome of a future event. A purchase price for a contingent security is set by the prediction market based on trading behavior for the contingent security. For example, when a user purchases a contingent security, the price can increase; when a user sells a contingent security, the price can decrease. An equilibrium price reflects a market consensus about the security's expected value, which corresponds to a market consensus about the likely outcome of the future event. By buying and selling contingent securities, users reveal beliefs about the likely outcome of the event. Because prediction markets tie economic participation with providing information about beliefs, users are more likely to provide information indicative of their true beliefs. Consequently, such prediction markets tend to provide better information about actual beliefs and opinions than polling and surveys.

### SUMMARY

This Summary is provided to introduce a selection of concepts in a simplified form that are further described below in the Detailed Description. This Summary is intended neither to identify key or essential features, nor to limit the scope, of the claimed subject matter.

A computer system implements an automated multi-user, multi-event real-time online prediction market, thus providing a more efficient and accurate mechanism to collect opinion information in digital form.

In a prediction market, the value of information received over time diminishes. The amount of liquidity in the market can be changed as a function of time to reflect how valuable information is at any given time. More liquidity means prices change more slowly as securities are purchased which means that the traders are able to make more money in the market and have higher incentive to reveal information. On the other hand, more liquidity means the operator of the market is open to more risk. So the market operator may be willing to offer high liquidity at first when information is valuable, but less willing as information becomes less valuable.

A prediction market that changes liquidity as a function of time can manage contingent securities for which partial information about the outcome is revealed prior to closing of the market for the security. This prediction market also can manage contingent securities for which utility of information from trading diminishes as the time of the outcome approaches. Such a prediction market also can manage and offer contingent securities for a set of interrelated events. Such a prediction market is known as a combinatorial prediction market.

A computer that implements a prediction market is programmed to (1) allocate a data structure for storing data describing a history of transactions, (2) access current time information and (3) define a cost function for the market such that liquidity of securities reduces or decays over time.

The data structure for the history of transactions can be a vector of a plurality of components, each component corresponding to one of the securities and storing data indicative of a historical quantity of transactions in the security. Current time can be represented in variety of ways, such as absolute or relative time, and such as a clock time or a number of transactions that have occurred.

The cost function defines a price for a security as a function of the historical quantity of the security from the data structure and a current time, such that liquidity of the security reduces over time. In one implementation, the cost function switches from a first function to a second function at a point in time prior to occurrence of an event; multiple switches can occur. In another implementation, the cost function can be time dependent so as to gradually change over time.

The computer system processes transactions related to the securities, and obtains status of the underlying events. When the outcomes of the underlying events are known, the market can close and payouts for the securities can be provided. The history of transactions stored in memory, combined with the programmed cost function, results in a computer system with a more efficient and accurate mechanism to gather opinion information in digital form.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example application environment in which a computer system hosts a multiple user, multiple event, real-time prediction market.

FIG. 2 illustrates an example implementation of database tables.

FIG. 3 is a flow chart describing operation of an example implementation of such a computer system.

FIG. 4 is a flow chart describing operation of an example implementation of switching cost functions at a particular time.

FIG. 5 is a flowchart describing an example implementation of a time-dependent cost function.

FIG. 6 is a block diagram of an example computer with which components of such a system can be implemented.

FIG. 7 is a data flow diagram illustrating an architecture of an example implementation of the server computer.

### DETAILED DESCRIPTION

A computer system collects digital representations of opinion data by implementing an online prediction market, allowing multiple users to engage in transactions related to a collection of contingent securities. The prediction market, as described in more detail below, implements a cost function that is modified over time so as to reduce liquidity of securities over time. For example, in one implementation, the cost function switches from a first function to a second function at a point in time prior to occurrence of an event; multiple switches can occur. In another implementation, the cost function can be time dependent so as to gradually change over time.

An example kind of prediction market addressed herein is a combinatorial prediction market which offers securities for a set of interrelated events. As an example, a security can be offered for “Country A wins four gold medals in the Winter Olympics” and another security can be offered for “Country A wins a gold medal in hockey.” Because the events underlying the securities are interrelated, the prices of the securities also should be dependent. In such a market, each transaction in a security can provide information relevant to some or all of the other securities. In addition, the outcome of an event underlying one security may be revealed prior to outcomes for other events underlying other securities. Partial information about an outcome also may be revealed over time. Thus, the value of information revealed by transactions over time may decrease as the outcome of the event nears.

This implementation also applies to markets with a small number of securities.

Implementation of a prediction market on a computer on a publicly accessible computer network allows the computer to collect opinion information in real time from multiple users based on users' transactions in contingent securities.

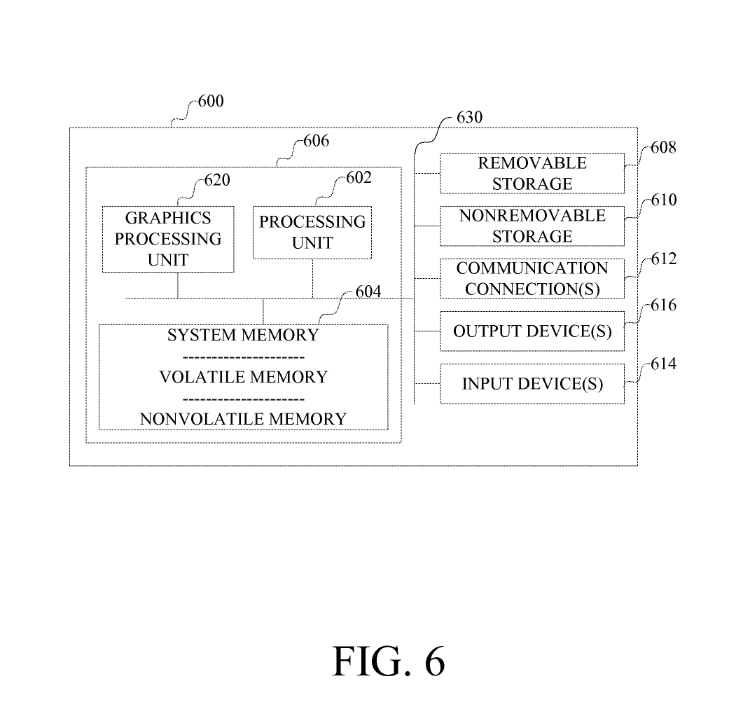

Such a computer system includes one or more computers, such as described below in connection with FIG. 6, which connect to one or more computer networks through one or more network interfaces and to a database that stores information in persistent storage. Users access the one or more computers through user devices that connect to the one or more computer networks. User devices also are typically a form of computer such as described below in connection with FIG. 6. The computer system collects and stores data about users, events, and transactions with multiple users for multiple contingent securities over a period of time. The computer system is initialized with the multiple contingent securities, and an interface through which users can make transactions is provided. The computer system processes transactions related to the securities, while tracking status of the underlying events. After the outcomes of the underlying events are known, the market can be closed and payouts for the securities can be provided.

The cost function of a prediction market can be described as follows. Let O denote an outcome space, which is a finite set of mutually exclusive and exhaustive outcomes for future events. The market provides a set of K securities on the outcome space O, and specifies a payoff function P: O→R^{K}, where P(w) denotes a vector of payoffs if the outcome wεO occurs. Each component of P(w) indicates the payoff of a particular security if the outcome is w. Thus, P(w) has K components, with each component corresponding to a particular security.

Any trader may purchase a bundle rεR^{K} of securities, with rᵢ denoting the quantity of a security i that the trader would like to purchase. A negative value of rᵢ can be permitted to represent short selling. A trader who purchases a bundle r of securities pays a specified cost for this bundle and receives a payoff of P(w)·r if the outcome wεO occurs.

A specific example of a cost function that can be useful for a prediction market is a convex potential function C: R^{K}→R. The current state of the market is summarized by a vector qεR^{K}, where qᵢ denotes a total number of shares of a security I that have been bought or sold so far. If the market state is q and a trader purchases a bundle r, then the trader pays the market C(q+r)−C(q). The new market state is q+r. The instantaneous price of a security I is dC(q)/dqᵢ if this derivative is well-defined. This instantaneous price is often considered the traders' collective belief about the payoff of the security.

As described in more detail below, a computer system implements a prediction market, which offers securities for a plurality of events which can be interrelated, and which is programmed to (1) allocate a data structure for storing data describing a history of transactions, (2) access current time information and (3) define a cost function for the market such that liquidity of securities reduces over time.

The data structure for the history of transactions can be a vector of a plurality of components, each component corresponding to one of the securities and storing data indicative of a historical quantity of transactions in the security. Thus, this vector can be used to represent the market state q used by the cost function C as described below. Current time can be represented in variety of ways, such as absolute or relative time, and such as a clock time or a number of transactions that have occurred.

The cost function defines a price for a security as a function of the historical quantity of the security from the data structure and a current time, such that liquidity of the security reduces over time. In one implementation, the cost function switches from a first function to a second function at a point in time prior to occurrence of an event; multiple switches can occur. In another implementation, the cost function can be time dependent so as to gradually change over time.

As a particular example of such a cost function switch, consider a standard cost function C as described above, and define C′=aC(q/a) for some parameter a, which is in a range of 0 to 1. The value of the parameter a controls how quickly prices change as purchases are made when the cost function C′ is used, effectively adjusting the liquidity of the market. In one implementation, at a predetermined point in time, a switch occurs from operating the market using the cost function C to operating the market using the cost function C′. At this switch time there is a one-time update of the market state by scaling the vector q by a. This results in a sudden liquidity switch without damaging other properties of the market such as bounded loss. In another implementation, the cost function can be parameterized by the time t. If at time t the market state is q and a trader purchases a bundle r, then the trader pays the market maker C(q+r; t)−C(q; t). Such a time dependent function can be viewed as a generalization of C′=a C(q/a), where a is a function oft with a range between 0 and 1 and is monotonic, and where the market state is updated between each switch.

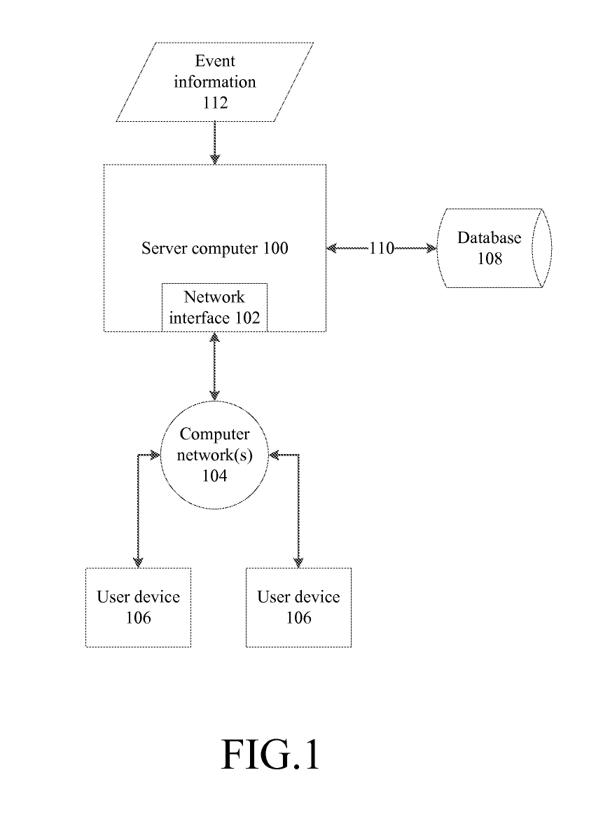

Referring to FIG. 1, an example implementation of such a computer system and its operating environment to provide such an online prediction market will now be described.

In FIG. 1, a server computer 100, which can be one or more computers, is maintained by a central service to host a computer system through which users can purchase contingent securities of a prediction market. The server computer 100 has one or more network interfaces 102 to connect to one or more computer networks 104. The computer network 104 allows user devices 106 to connect to and communicate with the server computer 100.

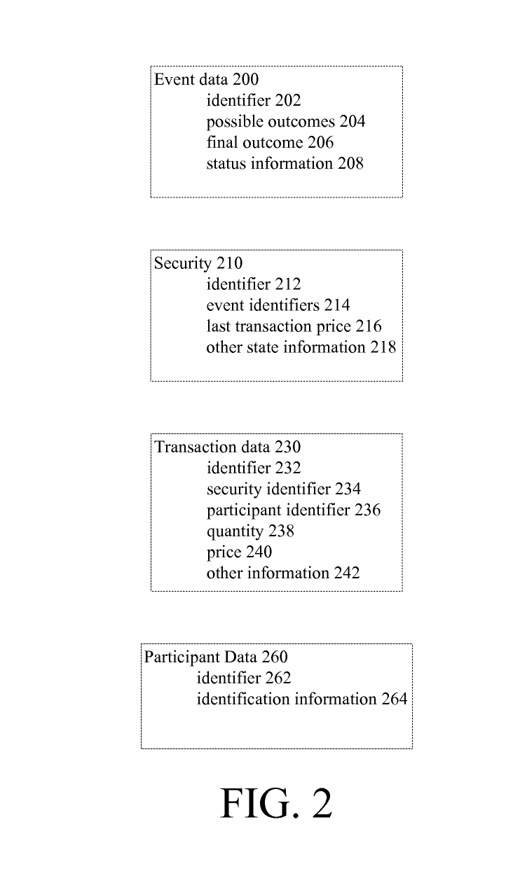

The server computer 100 also connects to one or more databases 108 through connection 110. The database 108 stores information about events, users and transactions placed for securities related to the events. Depending on the implementation of the database 108, such a connection 110 can be provided by a computer network, a computer bus, or other communication connection to access data in persistent storage. An example implementation of the database is described in more detail in connection with FIG. 2 below.

In general, in operation, users cause user devices 106 to access the server computer 100. The server computer 100 provides data about securities based on information from the database 108 to the user devices 106. The server computer 100 receives data from user devices about users and transactions to be placed for users in connection with the offered contingent securities, and stores the received data in the database 108. The server computer also receives information 112 about events, including times and outcomes of those events, and stores that information in the database. The server computer 100 also accesses data indicative of a current time 114. Such data can be, for example, from a time of day clock, a counter running from the opening of a market, a count of transactions occurring in the market, and the like.

There are a variety of possible implementations of such a computer system, depending on the environment in which it is deployed.

For example, the server computer may be connected to a publicly accessible computer network, such as the internet, and can accept connection requests from any kind of user device that can connect to the internet and communicate user, event and transaction information to and from the server computer to the user device. In such a case, any user device can be a mobile phone, television set top box, smart television, personal computer, portable computer, tablet, slate or other handheld computer, game console or the like.

As another example, the server computer and computer network can be deployed in a privately accessed facility, with a private local area network to which user devices can connect. User devices in such an implementation may include computer terminals, personal general purpose computers, and point of sale computers, dedicated to the function of placing transactions for events.

As another example, the server computer and computer network can be deployed for access by user devices that are programmed to participate automatically in events on behalf of individuals or organizations. In such an implementation, a user device may be a computer that acts as an interface to a machine learning system that is processing information to make predictions and then purchase securities.

Referring to FIG. 2, an example implementation of a database will now be described.

In this example, implementation, the computer system can store data describing events 200, securities 210, participants 260 and transactions 230.

For events, the computer system can store, for example, for each event underlying one or more securities, an identifier 202 for the event and a plurality of possible outcomes 204 of the event. Any other status information 206 for the event can be stored, such as descriptive information for the event. There may be multiple events, the possible outcomes of which define an outcome space for a set of securities. The actual outcomes of these events determine the payouts of the securities.

For securities, the computer system can store, for example, an identifier 212 of the security. One or more identifiers 214 of the events underlying the security can be stored. A variety of other data can be stored to relate securities to their underlying events, such as by storing indications of securities with the event data, or by storing indications of outcomes, or other data. A last transaction price 216 for the security or other state information 218 also can be stored.

For transactions, the computer system can store, for example, an identifier 232 of the transaction, an identifier 234 of a bundle of securities for which the transaction is placed, an identifier 236 of a participant engaging in the transaction, a quantity 238 of the security and a current price 240 for the security. To indicate a bundle of securities, the information stored for the transaction data can include a reference to a bundle, with information stored in a separate bundle data structure referencing data for each security in the bundle. In another implementation, the transaction data can list the data for each security in the bundle. Other information 242 also can be stored, such as the time at which the transaction occurred, or whether the transaction was accepted or rejected.

For participants, the computer system can store an identifier 262 of the participant and various identification information 264. For example, payment methods and contact information may be stored.

With such an implementation, the database can be implemented using a relational database including tables of data stored in tables in persistent storage and accessible through a relational database management system. Using such information it is possible to identify all wagers placed by a participant, and thus all events in which the participant placed wagers. The computer system also can query the database to identify all participants in an event, and all wagers in an event.

A similar database can be implemented using an object oriented database management system, or in data files accessed through a file system of an operating system of a computer. Such data files can be stored in persistent storage local to the server computer (i.e., connected over a bus) or in persistent storage accessed over a computer network.

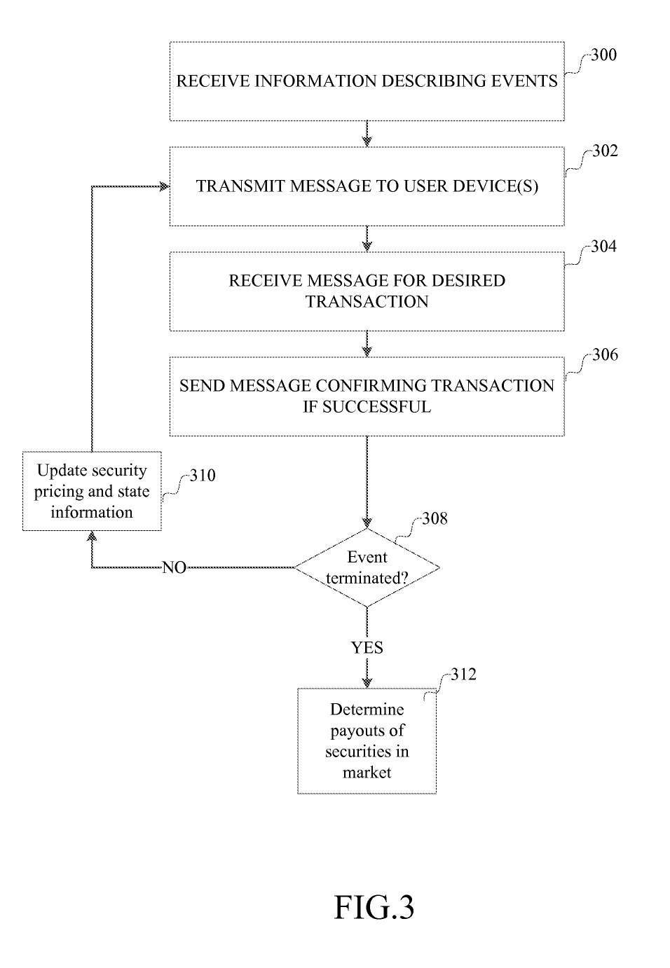

Referring now to FIG. 3, a flowchart of an example implementation of operation of a prediction market will now be described. To open such a market to allow trading in contingent securities, the computer system receives 300 information describing various events that will underlie the securities, and stores this information in the database.

When each user device accesses the computer system, the computer system transmits 302 a message to the user device including data describing securities which are currently available for the user associated with the user device. The information provided by the computer system to allow for a transaction may include various securities from which a selection can be made to create a bundle for purchase, and a mechanism to enter the selection and communicate about the current price for the bundle. To engage in a transaction, a user instructs the user device to transmit a message with the data describing the transaction. The computer system then receives 304 a message from the user device indicating the desired transaction.

The server computer processes the transaction from the user device and transmits 306 a message to the user device indicating whether the transaction is successful. Such processing can include verifying that the transaction is valid, such as whether the user is authorized to make the transaction, whether payment has been accepted, whether parameters of the transaction are within certain limits, or whether the transaction occurred in time prior to closing of the market. If the market has not closed, the security pricing is updated based on the information provided by the latest transaction, and any state information also is updated, as indicated at 310. Such transaction processing from multiple users continues until the server computer detects that the market is closing, as indicated at 308. After a market closes, the system determines payouts and closes 312 out the market.

The computer system generally performs the operational steps set forth in FIG. 3 asynchronously with other operations for other markets managed by the computer system. However, within the same market, transactions are generally processed sequentially, as each transaction in a security can affect the pricing of the securities in the bundle of any subsequent transaction. Other types of transactions, such as adding a user, adding a new market, offering other markets to a user, a user selecting market, transactions in different markets, and markets closing can occur asynchronously with other transactions.

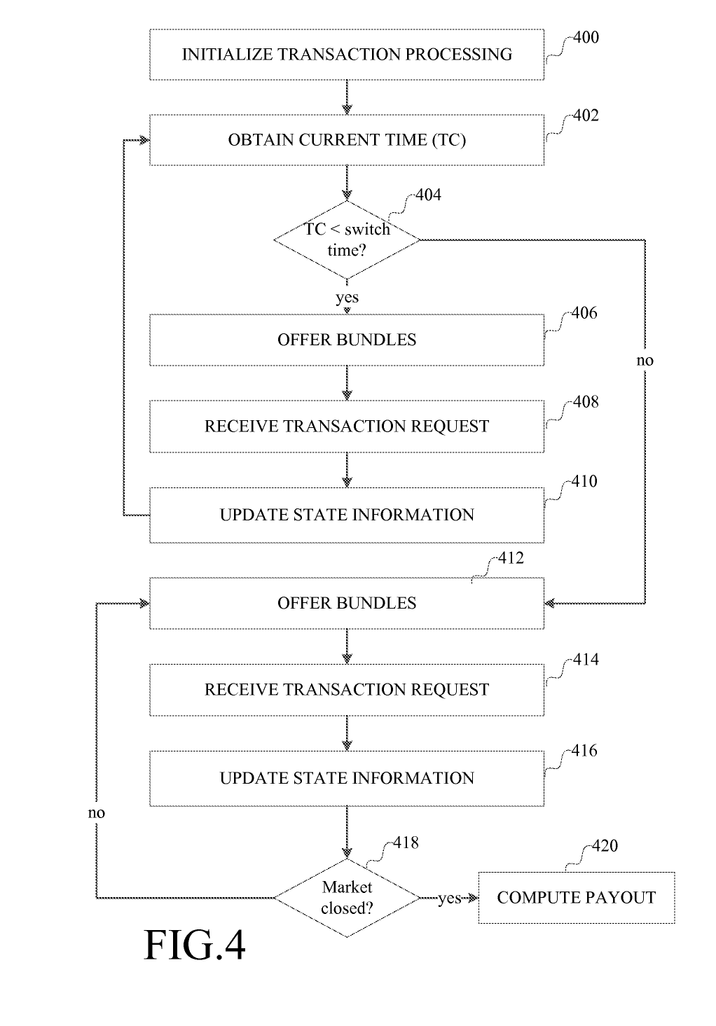

Referring now to FIG. 4, a flowchart of operation of an example implementation of a computer system will now be described. In this example, there is a future time t at which a change in a cost function will occur. The operation begins with an initial cost function and an initial state. The computer system is programmed to implement the first cost function prior to time t, and a second cost function after time t and until the market closes.

Thus, in FIG. 4, the computer operation begins by initializing 400 transaction processing. Initialization can involve instructing the computer to use a program implementing a first cost function and establishing data structures in memory for managing state information for the market. In addition, a data structure in memory, or record in a database, for storing a switch time is allocated and populated with a value for the switch time. A computer program also may specify where to locate code for updating the cost, using the first cost function, and code for updating the state. A source of the current time also can be identified.

Given a source of the current time, the current time is obtained as indicated at 402. If the current time is prior to the switch time, as indicated at 404, the first cost function is used. In particular, bundles of contingent securities for the market are offered 406. Such an offering can include computing a current cost for the bundles using the first cost function, and communicating information to user devices about the availability of such bundles. In response to such an offering, the computer system can receive 408 one or more transaction requests from one or more user devices. State information for the market is then updated 410. After accepting a transaction, the current time is again considered at 402 and 404, and further transactions can occur.

After the current time detected by the computer is later than the switch time set for the market, the process flow then switches to using a second cost function. As shown in FIG. 4, processing branches to offering 412 bundles of securities priced using the second cost function. At the time of the switch, the market state also can be scaled by a factor used to scale the cost function. The second cost function can be chosen adaptively according to the last state of the first cost function.

A computer program implementing the switch between a first cost function and a second cost function can do so by using the current time as a parameter in a single cost function, such that the function is effectively different before and after the designated switch time.

In an alternative implementation, the computer program can instruct the computer to start using the program code for a different cost function instead of using a branching instruction that causes the computer to start using a different portion of a computer program which in turn implements the different cost function.

After offering securities to users by sending messages to user devices, the computer system can receive 414 one or more transaction requests from one or more user devices. State information for the market is updated 416 after each transaction. If the time to close the market has not yet been reached as indicated at 418, then further transactions (412, 414, 416) can occur. After the close of the market, the payoff for each security can be computed and paid to the traders, as indicated at 420.

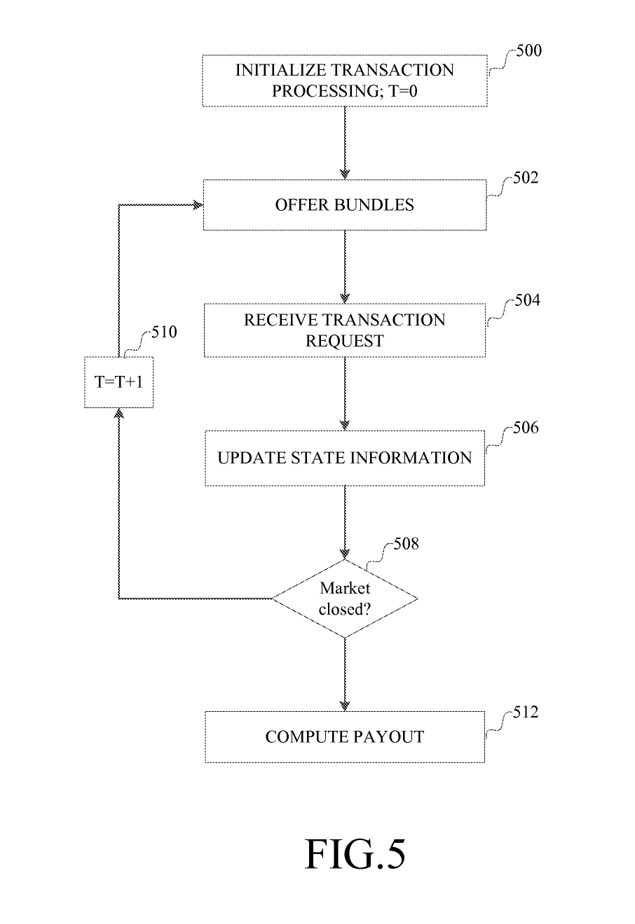

Referring now to FIG. 5, a flowchart of operation of another example implementation of a computer will now be described. In this example, as time passes while the market is open and until the market closes, the cost function varies over time. In this implementation, the passage of time is tracked by transactions, with the cost function being varied after each transaction.

Thus, in FIG. 5, the computer operation begins by initializing 500 transaction processing. Initialization can involve instructing the computer to use program code implementing a time-sensitive cost function. Data structures in memory or in a database are allocated and populated for storing state (e.g., history of transactions) and time information (e.g., an iteration number). Transaction processing thus can be carried out as an iterative loop, in which each iteration of a loop can provide a value t that can be used by the time-sensitive cost function to vary the cost function. For example, the amount of price change between transactions can be reduced as the value t increases, thus reducing liquidity over time. The transaction history also can be used to vary the cost function. For example, the amount of price change between transactions in a security can be reduced as the quantity of securities traded increases, thus reducing liquidity over time.

Given the initialized value, the computer system can offer 502 bundles at pricing given by the current cost function. The computer system then can receive 504 a transaction request for a bundle. If the transaction is accepted the state information and cost function is updated 506. If the time to close the market has not yet been reached as indicated at 508, then further transactions (504, 506) can occur using the cost function as updated using an updated (510) iteration value t. After the close of the market, the payoff for each security can be computed and paid to the traders, as indicated at 512.

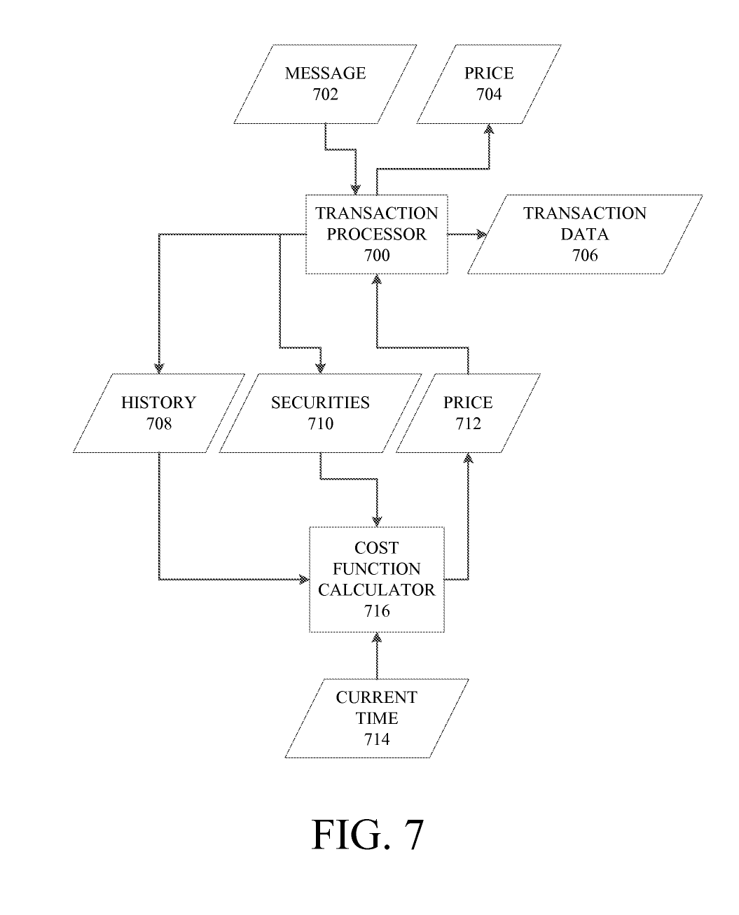

Referring now to FIG. 7, a data flow diagram illustrates an architecture of an example implementation of the server computer. In this example implementation, the server computer includes a transaction processor 700 that receives the messages 702 from user devices for engaging in transactions. As part of the messages communicated to user devices, the transaction processor also provides price information 704 for any requested securities. The transaction processor 700 also provides transaction data 706 to be stored in the databases (not shown in FIG. 7, but an example is shown in FIGS. 1 and 2).

As transactions are completed, the transaction processor also updates a history 708. The history is stored data that describes a history of transactions in the securities of the prediction market. This history can be implemented as a vector of a plurality of components, each component corresponding to one of the securities and storing data indicative of a historical quantity of transactions in the security. This data structure can be allocated in one of memory and persistent storage of the server computer. A cost function calculator 716 provides a price 712 to the transaction processor 700 for each security 710 or bundles of securities offered for transactions by the transaction processor 700. As noted above in connection with FIGS. 4 and 5, the cost function uses the history 708 and current time 714 to adjust the cost function to reduce liquidity over time.

Such a computer system implements an automated multi-user, multi-event real-time online prediction market, thus providing a more efficient and accurate mechanism to collect and store opinion information in digital form.

In one aspect, a server computer includes a processor, memory connected to the processor to allow access by the processor to data stored in the memory, persistent storage connected to the processor to allow access by the processor to data stored in the persistent storage, a network interface connected to the processor and the memory to allow access by the server computer to a computer network and to allow the server computer to communicate messages over the computer network to and from user devices, and computer program instructions stored in at least one of the memory and persistent storage. When processed by the processor, the computer program instructions instruct the processor to allocate a data structure, in one of the memory and the persistent storage, for storing data describing a history of transactions for a prediction market which offers securities for a plurality of events, the data structure comprising a vector of a plurality of components, each component corresponding to one of the securities and storing data indicative of a historical quantity of transactions in the security. The processor is further instructed to define at least one cost function for the market, the cost function defining a price for a security as a function of the historical quantity of the security from the data structure and a current time such that liquidity of the security reduces over time. The processor is further instructed to receive messages over the computer network from user devices, each received message including data indicative of a transaction in connection with at least one of the securities, the data specifying a quantity for each security of the at least one of the securities and a participant. The processor is further instructed to process the data for each transaction to store data indicative of the transaction in the persistent storage; determine a price for the transaction by applying the specified cost function to the at least one of the securities specified in the transaction, the quantity in the transaction for each security of the at least one of the securities, the historical quantity of the at least one of the securities, and a current time; to update the data in the data structure describing the history of transactions according to the data for the transaction. The processor is further instructed to repeat receiving messages and processing transactions until the market closes. After close of the market, the processor is further instructed to determine payoffs for the participants using the data stored in the persistent storage and outcomes of the events associated with the securities.

In another aspect, a server computer includes a transaction processor having an input for receiving messages from user devices and an input for receiving price information from a cost function calculator. The server computer also includes the cost function calculator which has an input for receiving data describing a history of transactions for a prediction market which offers securities for a plurality of events, the data structure comprising a vector of a plurality of components, each component corresponding to one of the securities and storing data indicative of a historical quantity of transactions in the security. The cost function calculator also has an input for receiving an indication of a current time, and an input for receiving an indication of securities requested in a transaction. Given these inputs, the cost function calculator provides a price as an output to the transaction processor. Data about valid transactions can be output by the transaction processor. Also, the history data structure can be updated by the transaction processor.

In another aspect, a server computer includes a means for processing transactions including receiving requests for transactions in a security and providing data about pricing for such transactions. The server computer also includes a means for calculating price information as a function of a current time, a history of transactions in securities and securities requested in a transaction.

In any of the foregoing aspects, the plurality of events can be a plurality of interrelated events in a combinatorial prediction market.

In any of the foregoing aspects, a database in the persistent storage stores one or more of transaction data, user data, and security data.

In any of the foregoing aspects, a database computer executing a database management system, is connected to the server computer and includes the persistent storage. The database computer is responsive to requests from the server computer to access data stored in the persistent storage.

In any of the foregoing aspects, data describing a security can include an outcome and an identifier for the security.

In any of the foregoing aspects, data describing a transaction can include an identifier of a participant and an identifier of a security.

In any of the foregoing aspects, data describing a participant can include an identifier of the participant and authorization information for the participant.

In any of the foregoing aspects, the specified cost function can includes monitoring a current time. If a current time is before a switch time, a first cost function is used. If a current time is after a switch time, then a second cost function is used.

In any of the foregoing aspects, the specified cost function includes a cost function that reduces liquidity as time increases.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

Having now described an example implementation of an online wagering system on a computer system, an example implementation of a computer as may be used to implement such a computer system will now be described. The computer generally includes computer hardware, such as described in FIG. 6 below, and computer programs providing instructions to be executed by the computer. Computer programs on a general purpose computer generally include an operating system and applications. The operating system is a computer program running on the computer that manages access to various resources of the computer by the applications and the operating system. The various resources generally include memory, storage, communication interfaces, input devices and output devices.

The computer can be any type of general-purpose or special-purpose computer, such as a tablet computer, hand held computer, smart phone, laptop or notebook computer, wearable computing device, or any other computing device, regardless of size or environment, more details and examples of which are discussed below in connection with FIG. 6.

FIG. 6 illustrates an example of computer hardware of a computer with which the various components of the system of FIGS. 1-5 and 7 can be implemented using computer programs executed on this computer hardware. The computer hardware can include any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, network PCs, minicomputers, mainframe computers, and distributed computing environments that include any of the above types of computers or devices, and the like.

With reference to FIG. 6, an example computer 600 includes at least one processing unit 602 and memory 604. The computer can have multiple processing units 602 and multiple devices implementing the memory 604. A processing unit 602 can include one or more processing cores (not shown) that operate independently of each other. Additional co-processing units, such as graphics processing unit 620, also can be present in the computer. The memory 604 may include volatile devices (such as dynamic random access memory (DRAM) or other random access memory device), and non-volatile devices (such as a read-only memory, flash memory, and the like) or some combination of the two. This configuration of memory is illustrated in FIG. 6 by dashed line 606. The computer 600 may include additional storage (removable and/or non-removable) including, but not limited to, magnetically-recorded or optically-recorded disks or tape. Such additional storage is illustrated in FIG. 6 by removable storage 608 and non-removable storage 610. The various components in FIG. 6 are generally interconnected by an interconnection mechanism, such as one or more buses 630.

A computer storage medium is any medium in which data can be stored in and retrieved from addressable physical storage locations by the computer. Computer storage media includes volatile and nonvolatile memory devices, and removable and non-removable storage media. Memory 604 and 606, removable storage 608 and non-removable storage 610 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage media and communication media are mutually exclusive categories of media.

Computer 600 may also include communications connection(s) 612 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media include any non-wired communication media that allows propagation of signals, such as acoustic, electromagnetic, electrical, optical, infrared, radio frequency and other signals. Communications connections 612 are devices, such as a network interface or radio transmitter, that interface with the communication media to transmit data over and receive data from signals propagated through communication media.

Computer 600 may have various input device(s) 614 such as a keyboard, mouse, pen, camera, microphone, touch input device, sensors, and so on. Output device(s) 616 such as a display, speakers, a printer, and so on may also be included. All of these devices are well known in the art and need not be discussed at length here. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various storage 610, communication connections 612, output devices 616 and input devices 614 can be integrated within a housing with the rest of the computer, or can be connected through various input/output interface devices on the computer, in which case the reference numbers 610, 612, 614 and 616 can indicate either the interface for connection to a device or the device itself as the case may be.

Each component (which also may be called a “module” or “engine” or the like), of a computer system such as described in FIGS. 1-5 above, and which operates on a computer, can be implemented using the one or more processing units of the computer and one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

This computer system may be practiced in distributed computing environments where operations are performed by multiple computers that are linked through a communications network. In a distributed computing environment, computer programs may be located in both local and remote computer storage media.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

It should be understood that the subject matter defined in the appended claims is not necessarily limited to the specific implementations described above. The specific implementations described above are disclosed as examples only.

What is claimed is:

1. A computer system comprising:
a server computer, comprising a processor, memory connected to the processor to allow access by the processor to data stored in the memory, persistent storage connected to the processor to allow access by the processor to data stored in the persistent storage, a network interface connected to the processor and the memory to allow access by the server computer to a computer network and to allow the server computer to communicate messages over the computer network to and from user devices, and computer program instructions stored in at least one of the memory and persistent storage of the server computer that, when processed by the processor, instruct the processor to:
allocate a data structure, in one of the memory and the persistent storage, for storing data describing a history of transactions for a prediction market which offers securities for a plurality of events, the data structure comprising a vector of a plurality of components, each component corresponding to one of the securities and storing data indicative of a historical quantity of transactions in the security;
define at least one cost function for the market, the cost function defining a price for a security as a function of the historical quantity of the security from the data structure and a current time such that liquidity of the security reduces over time;
receive messages over the computer network from user devices, each received message including data indicative of a transaction in connection with at least one of the securities, the data specifying a quantity for each security of the at least one of the securities and a participant;
process the data for each transaction to:
store data indicative of the transaction in the persistent storage,
determine a price for the transaction by applying the specified cost function to the at least one of the securities specified in the transaction, the quantity in the transaction for each security of the at least one of the securities, the historical quantity of the at least one of the securities, and a current time;
update the data in the data structure describing the history of transactions according to the data for the transaction;
repeat receiving messages and processing transactions until the market closes; and
after close of the market, determine payoffs for the participants using the data stored in the persistent storage and outcomes of the events associated with the securities.

2. The computer system of claim 1, wherein the plurality of events comprises a plurality of interrelated events.

3. The computer system of claim 1, further comprising a database, comprising:
a database computer executing a database management system, the database computer including the persistent storage and connected to the server computer over a computer network, the database computer responsive to requests from the server computer to access data stored in the persistent storage.

4. The computer system of claim 2, wherein data describing a security includes an outcome and an identifier for the security.

5. The computer system of claim 4, wherein data describing a transaction includes an identifier of a participant and an identifier of a security.

6. The computer system of claim 5, wherein data describing a participant includes an identifier of the participant and authorization information for the participant.

7. The computer system of claim 1, wherein the specified cost function includes:
monitoring a current time;
if a current time is before a switch time, using a first cost function; and
if a current time is after a switch time, using a second cost function.

8. The computer system of claim 1, wherein the specified cost function includes a cost function that reduces liquidity as time increases.

9. A computer implemented process performed by a server computer, comprising a processor, memory connected to the processor to allow access by the processor to data stored in the memory, persistent storage connected to the processor to allow access by the processor to data stored in the persistent storage, a network interface connected to the processor and the memory to allow access by the server computer to a computer network and to allow the server computer to communicate messages over the computer network to and from user devices, and computer program instructions stored in at least one of the memory and persistent storage of the server computer that, when processed by the processor, instruct the processor to perform a process comprising:
allocate a data structure, in one of the memory and the persistent storage, for storing data describing a history of transactions for a prediction market which offers securities for a plurality of events, the data structure comprising a vector of a plurality of components, each component corresponding to one of the securities and storing data indicative of a historical quantity of transactions in the security;
define at least one cost function for the market, the cost function defining a price for a security as a function of the historical quantity of the security from the data structure and a current time such that liquidity of the security reduces over time;
receive messages over the computer network from user devices, each received message including data indicative of a transaction in connection with at least one of the securities, the data specifying a quantity for each security of the at least one of the securities and a participant;
process the data for each transaction to:
store data indicative of the transaction in the persistent storage,
determine a price for the transaction by applying the specified cost function to the at least one of the securities specified in the transaction, the quantity in the transaction for each security of the at least one of the securities, the historical quantity of the at least one of the securities, and a current time;
update the data in the data structure describing the history of transactions according to the data for the transaction;
repeat receiving messages and processing transactions until the market closes; and
after close of the market, determine payoffs for the participants using the data stored in the persistent storage and outcomes of the events associated with the securities.

10. The computer implemented process of claim 9, wherein the persistent storage includes a database that stores transaction data and user data.

11. The computer implemented process of claim 9, wherein the computer system further comprises a database computer executing a database management system, the database computer including the persistent storage and connected to the server computer over a computer network, the database computer responsive to requests from the server computer to access data stored in the persistent storage.

12. The computer implemented process of claim 10, wherein data describing a security includes an outcome and an identifier for the security.

13. The computer implemented process of claim 12, wherein data describing a transaction includes an identifier of a participant and an identifier of a security.

14. The computer implemented process of claim 13, wherein data describing a participant includes an identifier of the participant and authorization information for the participant.

15. The computer implemented process of claim 9, wherein the specified cost function includes:
monitoring a current time;
if a current time is before a switch time, using a first cost function; and
if a current time is after a switch time, using a second cost function.

16. The computer implemented process of claim 9, wherein the specified cost function includes a cost function that reduces liquidity as time increases.

17. An article of manufacture comprising:
computer storage having computer program instructions stored in the computer storage, that, when executed by a computer having a processor, memory connected to the processor to allow access by the processor to data stored in the memory, and persistent storage connected to the processor to allow access by the processor to data stored in the persistent storage and a network interface connected to the processor and the memory to allow access by the computer to a computer network and communicate messages over the computer network, wherein the computer program instructions, when processed by the processor, instruct the processor to perform a process comprising:
allocate a data structure, in one of the memory and the persistent storage, for storing data describing a history of transactions for a prediction market which offers securities for a plurality of events, the data structure comprising a vector of a plurality of components, each component corresponding to one of the securities and storing data indicative of a historical quantity of transactions in the security;
defining at least one cost function for the market, the cost function defining a price for a security as a function of the historical quantity of the security from the data structure and a current time such that liquidity of the security reduces over time;
receiving messages over the computer network from user devices, each received message including data indicative of a transaction in connection with at least one of the securities, the data specifying a quantity for each security of the at least one of the securities and a participant;
processing the data for each transaction to:
store data indicative of the transaction in the persistent storage,
determine a price for the transaction by applying the specified cost function to the at least one of the securities specified in the transaction, the quantity in the transaction for each security of the at least one of the securities, the historical quantity of the at least one of the securities, and a current time;
update the data in the data structure describing the history of transactions according to the data for the transaction;
repeating receiving messages and processing transactions until the market closes; and
after close of the market, determining payoffs for the participants using the data stored in the persistent storage and outcomes of the events associated with the securities.

18. The article of manufacture of claim 17, wherein the specified cost function includes:
monitoring a current time;
if a current time is before a switch time, using a first cost function; and
if a current time is after a switch time, using a second cost function.

19. The article of manufacture of claim 17, wherein the specified cost function includes a cost function that reduces liquidity as time increases.

20. The article of manufacture of claim 17, wherein the persistent storage includes a database that stores security and transaction data.
